(19) United States
(12) Patent Application Publication
(10) Pub. No.: US 2024/0242953 A1
(43) Pub. Date: Jul. 18, 2024

(54) ION FOCUSING AND MANIPULATION

(71) Applicant: Purdue Research Foundation, West Lafayette, IN (US)

(72) Inventors: Robert Graham Cooks, West Lafayette, IN (US); Brett M. Marsh, West Lafayette, IN (US)

(21) Appl. No.: 18/563,569

(22) PCT Filed: May 26, 2022
(86) PCT No.: PCT/US2022/031043

§ 371 Date: Nov. 22, 2023

Related U.S. Application Data
(60) Provisional application No. 63/194,452, filed on May 28, 2021.

(51) Int. Cl. H01J 49/06; H01J 49/16

(52) U.S. Cl. CPC H01J 49/065; H01J 49/16

(57) ABSTRACT

The invention generally relates to systems and methods for focusing ions using counter flows of opposite or like charged ions. In certain embodiments, oppositely charged ions are introduced in a counter flow to a target ion beam within an atmospheric ion guide.

### RELATED APPLICATION

The present application claims the benefit of and priority to U.S. provisional patent application Ser. No. 63/194,452, filed May 28, 2021, the content of which is incorporated by reference herein in its entirety.

### GOVERNMENT INTEREST

This invention was made with government support under CHE1905087 awarded by the National Science Foundation. The government has certain rights in the invention.

### FIELD OF THE INVENTION

The invention generally relates to systems and methods for ion focusing and manipulation.

### BACKGROUND

Electrospray ionization is commonly employed in modern mass spectrometry experiments for applications ranging from proteomics to environmental science and for fundamental studies of the chemical reactivity of ions. Despite the ubiquity of electrospray ionization, the total ion currents achieved using the technique remain relatively poor. While there are significant losses within the atmospheric pressure interface of the mass spectrometer (MS), many ions are lost due to space charge repulsion before ions and charged microdroplets enter the instrument. Space charge effects also limit the extent to which multiplexing of electrosprays can be used to increase ion currents.

The widespread adoption of electrospray ionization as well as other ambient ionization techniques as ion sources for MS has been paralleled by an increased interest in the physics of ions and charged microdroplets under ambient conditions. Surprising effects, such as strong ambient ion and microdroplet focusing, have been observed. For instance, ions passing through an aperture, such as a grid, have been observed to focus into spots up to 10× smaller than the grid apertures. Subsequent work has shown that ions can be transported in the air while maintaining focus using shaped electrodes electrode arrays. Stacked apertures have also been used to create well-focused beams of ions from ESI sources. In contrast to conventional, vacuum-based ion manipulation, where the ion motion is dictated by the mass-to-charge (m z) of the ion and in which a combination of DC and radiofrequency (RF) fields is often employed to control position and velocity, the motion of an ion at ambient pressure is related to its electrical mobility and is easily controlled through the use of DC-only potentials. Similar to in-vacuum ion optics, focusing devices and ion guides are now being developed to manipulate ions at high (viz. ambient) pressures.

Ions and droplets under ambient conditions are, due to collisions with background gases, quickly thermalized and move with low kinetic energies. Under these low-velocity conditions, space charge effects become particularly pronounced, leading to a loss of ion current entering the mass spectrometer. The expansion of the dimensions of a beam of ions due to space charge can be described by the equation:

$$\frac{z}{{r}_{0}} = {[ \frac{4.924 {V}^{3 / 4}}{{m}^{1 / 4} {I}^{1 / 2}} ]}^{1 / 2} {\int }_{0}^{\sqrt{l n \frac{r}{{r}_{0}}}} {e}^{{t}^{2}} dt$$

where z is the axial displacement, r₀ is the initial beam radius, V is the acceleration potential, m is the ion mass, I is the ion current, r is the beam waist at time t and unit charge on the ion is assumed.

Efforts to increase the ion signal at a mass spectrometer through multiplexing ion sources have been hampered by the effects of diverging electrical potentials and space charge from the droplet plumes produced by multiple emitters. While electrodes can be used to shape ion beams from ESI emitters, merging these beams is still a challenge. Practical methods for reducing space charge require either lowering the current produced by the emitter or spatially separating the emitters. Both of these tactics are detrimental to ion signal and signal density. A third approach, the neutralization of space charge by a counterion beam, was first proposed in the 1920s by Kingdon and Langmuir. Since their initial studies, which focused on atomic ions created from the ionization of mercury vapors or rare gas ions generated by filament-produced electrons in sealed tubes, this methodology has been used to control electron and atomic ion beams in accelerators as well as to enhance the sensitivity of inductively coupled plasma mass spectrometry (ICP-MS) and intense laser ion sources. The ionization of background gas by uranium (U⁺) ions to give associated gaseous anions was also used to compensate for space charge in calutrons for the Manhattan project. However, all these results have utilized atomic ions and most have utilized high energies and low pressures, making them unsuited for the focusing and transmission of atmospheric pressure ions. Moreover, none of them have dealt with molecular ions, the subject of central interest in much of modern mass spectrometry.

### SUMMARY

The invention provides systems and methods for manipulating and focusing molecular ions produced by electrospray ionization or other methods at atmospheric pressure using ions of the same charge or opposite charge as focusing elements. Methods of the invention take advantage of repulsive or attractive coulombic forces between ions to counteract space charge effects in mass spectrometry or other techniques requiring focused ion beams.

Aspects of the invention include an apparatus for ion focusing. Apparatuses of the invention can include a chamber having a distal end and a proximal end; a first ion source positioned to introduce a first beam of ions into the chamber near the distal end and directed toward the proximal end; and a second ion source positioned to introduce a second beam of ions oppositely charged to the first beam of ions into the chamber near the proximal end and directed toward the distal end. The first and second ion sources can be positioned such that the second beam of ions interacts with the first beam of ions to focus the first beam of ions as it travels from the distal end toward the proximal end.

In certain embodiments, the chamber may be an atmospheric ion guide. The atmospheric ion guide may be curved. Apparatuses of the invention may further comprise a plurality of electrodes along walls of the chamber. The plurality of electrodes may be of a same polarity as the first beam of ions. The plurality of electrodes can be positioned successively along the chamber walls from the distal end to the proximal end, separated by dielectric material, and supplied with progressively lower voltages from the distal end to the proximal end.

In some embodiments, the first and second ion sources may be independently selected from the group consisting of electrospray ionization (ESI), nano electrospray ionization (nESI), atmospheric pressure chemical ionization (APCI), atmospheric Pressure Photoionization (APPI), desorption electrospray ionization (DESI), nano-DESI, matrix-assisted laser desorption/ionization (MALDI), and laser ablation electrospray ionization (LAESI). In certain embodiments, the first ion source can comprise nESI. The second ion source may comprise APCI.

Apparatuses of the invention may include a third ion source positioned to introduce a third beam of ions oppositely charged to the first beam of ions into the chamber near the proximal end and directed toward the distal end. The first, second, and third ion sources can be positioned such that the second beam and third beams of ions interact with the first beam of ions to focus the first beam of ions as it travels from the distal end toward the proximal end. The second and third ion sources may be positioned to introduce ions into the chamber at side walls of the chamber. The second and third ion sources can be positioned approximately opposite each other on the side walls of the chamber. In certain embodiments, apparatuses of the invention may comprise a mass spectrometer positioned near an opening in the distal end of the chamber, the opening positioned at a focal point of the first beam of ions.

In certain aspects method for focusing ions are disclosed. Methods may include introducing a first beam of ions near a distal end of a chamber and directed toward a proximal end of the chamber; and introducing a second beam of ions oppositely charged to the first beam of ions near the proximal end of the chamber and directed toward the distal end such that the second beam of ions interacts with the first beam of ions to focus the first beam of ions as it travels from the distal end toward the proximal end.

### BRIEF DESCRIPTION OF THE DRAWINGS

FIG. 1 shows a rendering of an exemplary countercurrent space charge reduction device. Positive ions are generated by nESI on the left and flow to the right, while negative ions are generated by APCI at the bottom and flow upwards and towards the left.

FIG. 2 panels A-B show SIMION trajectories of positive (red, FIG. 2 panel A) and negative (blue, FIG. 2B) ions with voltages and ion sources annotated. The red contours in FIG. 2 panel B correspond to the electric field lines of the device. Note that the negative ion packets remain on the periphery of the device while positive ions move through the center.

FIG. 3 panels A-D show IonCCD images of a mixture of TAA ions (FIG. 3 panel A) with the outside APCI needle held at (FIG. 3 panel B) 20 μA, inside needle held at (FIG. 3 panel C) 20 μA, and both needles held at 20 μA (FIG. 3 panel D). Note that 1 IonCCD count unit represents 100 charges detected by the IonCCD. Control experiments with a 100 μM ethyl TAA solution, indicated that narrowing is only observed in the case where both the negative outside APCI and the positive spray are on.

FIG. 4 panels A-C show ion packet cross section measurements obtained using the IonCCD for the outside (FIG. 4 panel A), inside (FIG. 4 panel B), and both (FIG. 4 panel C) needles with the TAA mixture.

FIG. 5 panel A shows the ratio of intensities for APCI on/off with increasing current for a 25 μM (each) mixture of TAA's with the outside needle only.

FIG. 5 panel B shows the ratio of intensities for APCI on/off with increasing current for TAA mixture with the inside needle only.

FIG. 5 panel C shows the ratio of intensities for APCI on/off with increasing current TAA mixture with both needles used. Red dashed lines correspond to the no-enhancement case.

FIG. 6 shows spectra of ethyl TAA with spray only (black), negative APCI+nESI (red), and negative APCI only (blue). Note the lack of signal when only APCI is employed, indicating that the observed focusing results from the interaction of positive and negative ions.

FIG. 7 shows IonCCD images of ethyl TAA with no APCI voltage applied (black) and ethyl TAA with APCI voltage applied to a flat metal rod in place of the APCI voltage (red). Note that in this configuration, no ions are generated by APCI.

FIG. 8 panels A-E show IonCCD images of the TAA mixture with the outside APCI needle held at (FIG. 8 panel A) 0 μA, (FIG. 8 panel B) 5 μA, (FIG. 8 panel C) 10 μA, (FIG. 8 panel D) 15 μA, and (FIG. 8 panel E) 20 μA. 1 IonCCD count unit represents 100 charges detected by the IonCCD.

FIG. 9 panels A-E show IonCCD images of the TAA mixture with the inside APCI needle held at (FIG. 9 panel A) 0 μA, (FIG. 9 panel B) 5 μA, (FIG. 9 panel C) 10 μA, (FIG. 9 panel D) 15 μA, and (FIG. 9 panel E) 20 μA. 1 IonCCD count unit represents 100 charges detected by the IonCCD.

FIG. 10 panels A-E show IonCCD images of the TAA mixture with both APCI needles held at (FIG. 10 panel A) 0 μA, (FIG. 10 panel B) 5 μA, (FIG. 10 panel C) 10 μA, (FIG. 10 panel D) 15 μA, and (FIG. 10 panel E) 20 μA. 1 IonCCD count unit represents 100 charges detected by the IonCCD™.

FIG. 11 panels A-C show horizontal ion packet cross section measurements obtained using the IonCCD for the outside (FIG. 11 panel A), inside (FIG. 11 panel B), and both (FIG. 11 panel C) needles with the TAA mixture.

FIG. 12 panels A-E show IonCCD images of an octyl TAA solution with the outside APCI needle held at (FIG. 12 panel A) 0 μA, (FIG. 12 panel B) 5 μA, (FIG. 12 panel C) 10 μA, (FIG. 12 panel D) 15 μA, and (FIG. 12 panel E) 20 μA. 1 IonCCD count unit represents 100 charges detected by the IonCCD.

FIG. 13 panels A-E show IonCCD images of an ethyl TAA solution with the outside APCI needle held at (FIG. 13 panel A) 0 μA, (FIG. 13 panel B) 5 μA, (FIG. 13 panel C) 10 μA, (FIG. 13 panel D) 15 μA, and (FIG. 13 panel E) 20 μA. 1 IonCCD count unit represents 100 charges detected by the IonCCD.

FIG. 14 panel A-B show IonCCD cross sections taken at the 6.4 mm-horizontal position for (FIG. 14 panel A) ethyl and (FIG. 14 panel B) octyl TAA's under varying current conditions.

FIG. 15 panel A shows the ratio of intensities for APCI on/off with increasing current for a 100 μM solution of either ethyl or octyl TAA's with the outside needle only.

FIG. 15 panel B shows the ratio of intensities for APCI on/off with increasing current with the inside needle only.

FIG. 15 panel C shows the ratio of intensities for APCI on/off with increasing current with both needles used.

### DETAILED DESCRIPTION

Systems and methods of the invention relate to control of molecular ion motion using ion/ion interactions for the purpose of increasing performance in mass spectrometry (e.g., increasing resolution, ion abundance, etc.). In various embodiments, focusing ion beams may be used for purposes other than mass spectrometry, including in chemical analysis and in preparative/materials modification applications. Molecular ion focusing can be performed using other ions as focusing agents under ambient or vacuum conditions and using repulsive or attractive coulombic forces. The ions used for focusing can be chosen so as not to react with or otherwise interfere with measurement of the analyte ions (they can be chosen to be very different in mass for example). Additionally, the ions used for focusing can be very slow moving (or very fast moving). Coulombic repulsion between ions of like charge can be used to squeeze a beam of analyte ions, thereby decreasing angular spread and increasing flux/area provided they are separated from the analyte beam, e.g. in an annular geometry. Space charge neutralization using beams of molecular ions of opposite charge can be used to increase ion fluxes and signal levels provided they occupy the same region of space.

The forces that cause ion motion are of three types: forces due to electromagnetic (EM) fields, pneumatic forces and the forces due to ion/ion (coulombic) interactions. The motion of ions in vacuum is controlled conventionally by electro/magnetic fields. These fields are established readily by application of potentials to suitably placed and shaped electrodes.

Under non-zero pressures, pneumatic forces due to flowing gases can make a major contribution to ion motion. In addition, viscous drag forces operate when ions move through static media under electrical forces. Viscous drag, which is essentially a pneumatic force imposed on a particle moving through a fluid, is key at high pressure. This viscous drag even changes how space charge influences particles at atmospheric pressure. Consider the case where two particles are repelling each other in 1D space. In vacuum or ambient conditions, the force on the particles due to space charge is the same. However, under ambient conditions a drag force acts in the opposite direction to the space charge force, assuming space charge is the only force present. Therefore, space charge is less influential at atmospheric pressure than in vacuum. This is almost certainly why simulations using SIMION which do not consider space charge, are accurate for atmospheric pressure ions despite their low velocities. This is also partly why the beams don't show high amounts of divergence after focusing at atmospheric pressure.

As ion concentrations increase (and initial velocities decrease) forces due to mutual interactions between ions, may have non-negligible effects on ion motion. These coulombic forces can be attractive (opposite changes) or repulsive (like charges). In the case of ions of like charge, the forces (commonly referred to as space charge effects) and their consequences for ion motion are well understood, at least for atomic ions under vacuum conditions. At higher pressures viscous drag forces change how space charge influences ion motion. For example, under ambient conditions, a drag force acts in the opposite direction to the space charge force, reducing its influence.

The most common routine for simulation of ion motion in mass spectrometry is the SimION program. The program gives remarkably good agreement with experiment for ambient pressure, even though space charge forces are not included, perhaps because of the drag force just noted and the screening effect of ion/induced dipole and other ion/gas molecule interactions.

In certain embodiments, a flow of oppositely-charged ions produced by atmospheric pressure chemical ionization (APCI) can be employed to mitigate space charge effects in an analyte ion beam produced by nano electrospray ionization (nESI) as it is passed through an atmospheric pressure ion guide outside of a mass spectrometer. A decrease in the nESI beam width together with an increase in peak intensity can be observed using an ion charge coupled detector in the presence of a counterflow of ions of the opposite charge. This result indicates that focusing occurs in the ion guide. Measurement of the space charge compensated ion beam using an Agilent Ultivo triple quadrupole mass spectrometer are correlated with changes in ion focusing, indicating that space charge compensation occurring before the ion beam enters the mass spectrometer can increase detected ion currents.

In one example, a beam of ions produced via nanoelectrospray ionization (nESI), guided through a curved 3D-printed atmospheric pressure ion guide, was exposed to a beam of ions of opposite polarity produced through atmospheric pressure chemical ionization (APCI) in the same device. The spatial distribution of the ion beam and the absolute intensity of the ion signal were measured using an IonCCD™ detector when ions of both polarities were introduced into the ion guide.

### Experimental Details—Electrode Design

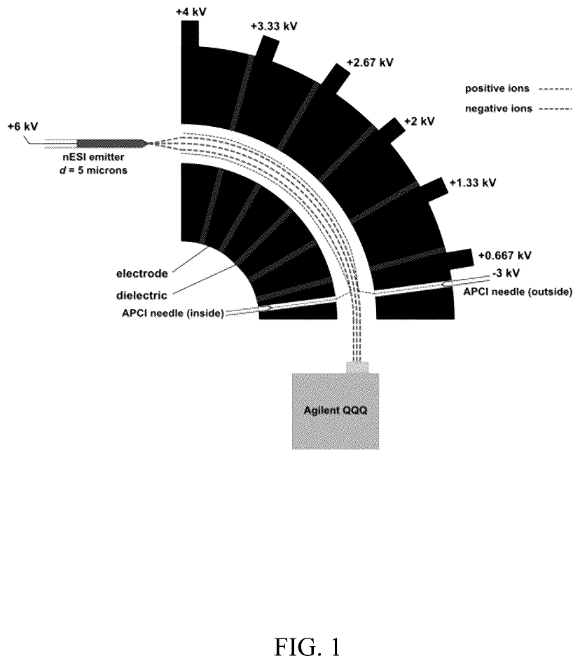

Electrode designs were generated using AutoCAD software and imported as stereolithography (.stl) files into Simplify 3D, a slicing software, to break up the model into “layers”. The layers were then imported as G-code to a MendelMax 3 3D printer. The electrodes used in this experiment were printed using carbon-doped polylactic acid (PLA) plastic while non-conductive portions of the device were printed from standard PLA plastic. A schematic view of the nested cylindrical device is shown in FIG. 1. The electrodes were powered by a Bertan 5 kV power supply held at 4 kV. Electrode potentials were adjustable from 4.000 kV to 0.667 kV in 667 V increments. An nESI emitter (5 μm pulled glass) was placed in the opening of the first (4 kV) electrode, while two APCI needles were placed perpendicularly to the opening of the 0.667 kV electrode on the inside and outside of the turn of the cylindrical device (the “inside needle” and “outside needle” respectively). The nESI emitter was held at a positive potential, while the APCI needles were held at a negative potential. All current measurements associated with the APCI needle are taken from the negative power supply display.

### IonCCD and Mass Spectrometry Measurements

The cross-sections of the ion packets were recorded using an IonCCD detector. Briefly, the IonCCD has a detector planar array that is composed of 2,126 21 μm-wide titanium nitride (TiN) pixels, each 1.5 mm in height. The effective resolution is 24 microns. Incoming ions give rise to the current recorded by the IonCCD software. For these experiments, the current was recorded over a time of 100 ms and 2D profiles were generated by manually scanning the IonCCD horizontally across the spray plume. For these experiments, the pixel row was oriented vertically, allowing for the recording of a two-dimensional image by moving the detector to the next horizontal position (separated by the pixel width) and repeating the measurement. The intensity of features in the IonCCD spectrum is given in counts, with 1 count unit corresponding to 100 elementary charges.

The mass spectra in this work were recorded using a modified Agilent Ultivo triple quadrupole mass spectrometer. 7 Briefly, the Ultivo source interlock was removed to allow use of the spectrometer with home-built ion sources. The 3D-printed electrode array was held on a ring stand with the 0.667 kV electrode held ˜5 mm from the Ultivo capillary inlet. The capillary shield was replaced with a prototype nESI shield to block the sheath gas from flowing into the 3D-printed electrode array.

### Simulations

Simulation of ion trajectories was performed using the statistical diffusion simulation (SDS) model in SIMION 8.1. Briefly, SDS is a computationally efficient method for simulation of collisions of ions with background gas. Diffusion of ions is simulated by random jumps of ions at each time step. The jump distance is determined by collision statistics calculated for the ion of interest at a given pressure. A more thorough description of the SDS model is given in ref. 16. The SDS algorithm has been previously validated for simulations of atmospheric ion transport and some applications to ion mobility.

### Results and Discussion—Ion Focusing

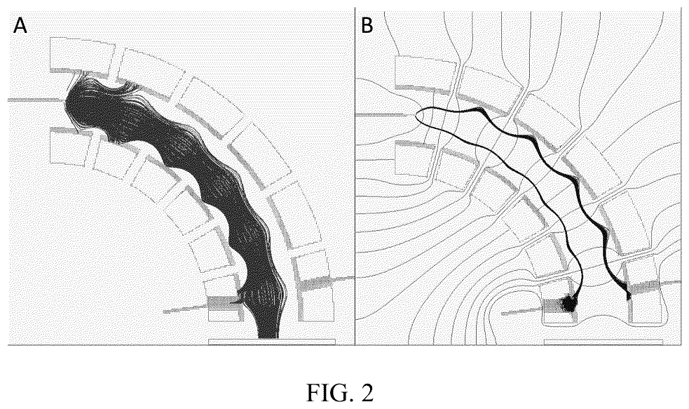

The SIMION predicted paths of positive (red) and negative (blue) ions are shown in FIG. 2 panels A-B. For these simulations, the nESI emitter was held at 6 kV, while both APCI needles were held at −3 kV. The negative ions originated near the two APCI needles while the positive ions originate at the nESI emitter. The negative ions do not travel in the middle of the device, but instead move along the periphery of the device, in opposition to the positive ions that are centered throughout the turn. The ions were grouped in their simulated travel; however, the oscillations observed are simply the result of the positioning of the (small number) of electrodes. Note that while the negative ions do exhibit some losses on the walls of the electrode, the majority are carried into the high potential region near the nESI emitter. The electric field contour lines (red lines, FIG. 2 panel B) show the steepest gradient near the edges of the electrode, consistent with the movement of negative ions towards the periphery of the device. The positive ion path is consistent with that previously predicted for a similar device, indicating that the negative potential from the needle does not strongly influence the positive ion path. It should be noted that the simulation presented here represents only fully desolvated ions and the influence upon droplets or clusters is not known. A further effect that is not considered is the ability of electrons to “hop” between molecules in the air, effectively increasing the speed of ion transport.

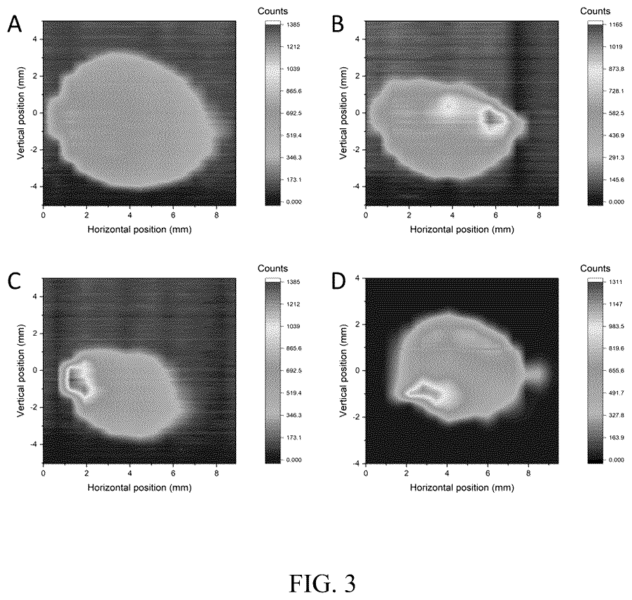

To characterize the performance of the atmospheric pressure ion guide in the absence of negative ions, the ion packet was recorded using the IonCCD with positive nESI (+6 kV) being used to ionize a mixture of 25 μM (each) of tetraethylammonium (ethyl TAA), tetrabutylammonium (butyl TAA), tetrahexylammonium (hexyl TAA), and tetraoctylammonium (octyl TAA) bromide (Sigma Aldrich) in acetonitrile (FIG. 3 panel A). Similar to previous work, 7 a flat intensity distribution with a full-width half-maximum (FWHM) of ˜7 mm was observed. Upon application of 20 μA of current to the outside APCI needle, the ion packet for the mixture (FIG. 3 panel B) narrows and shows an overall modest intensity increase on the outside edge compared to the case where no voltage is applied to the APCI needles (for readability, this will be referred to as the “no APCI case”). As shown in FIG. 3 panel C, the inside APCI needle results in similar focusing behavior, although focusing is now localized on the inside edge of the ion packet. Application of a 20 μA current at both needles simultaneously results in symmetrical focusing of the ion packet (FIG. 3 panel D). Intriguingly, there is a vertical shift in the ion packet intensity despite the injection of ions directly into the middle of the beam. This is likely due to the ions being deflected by fields at the edges of the electrodes or by fields around the exit of the ion creation channel entering the tube.

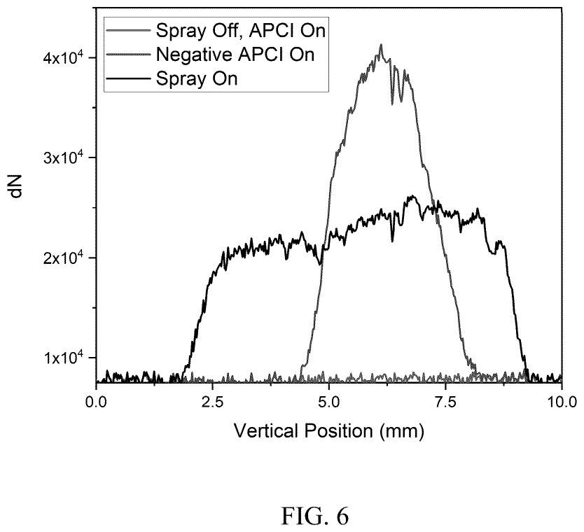

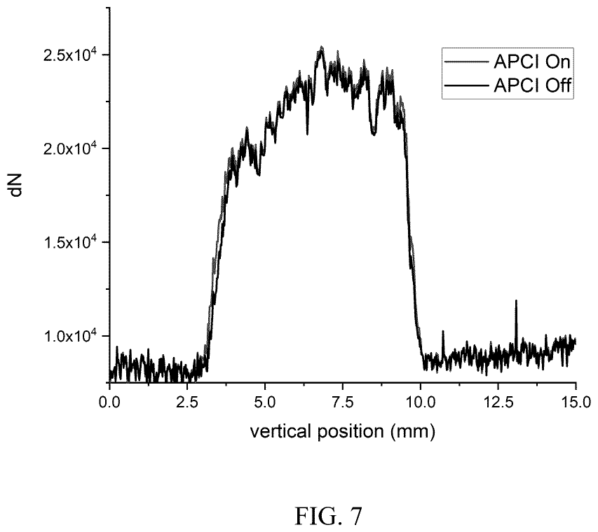

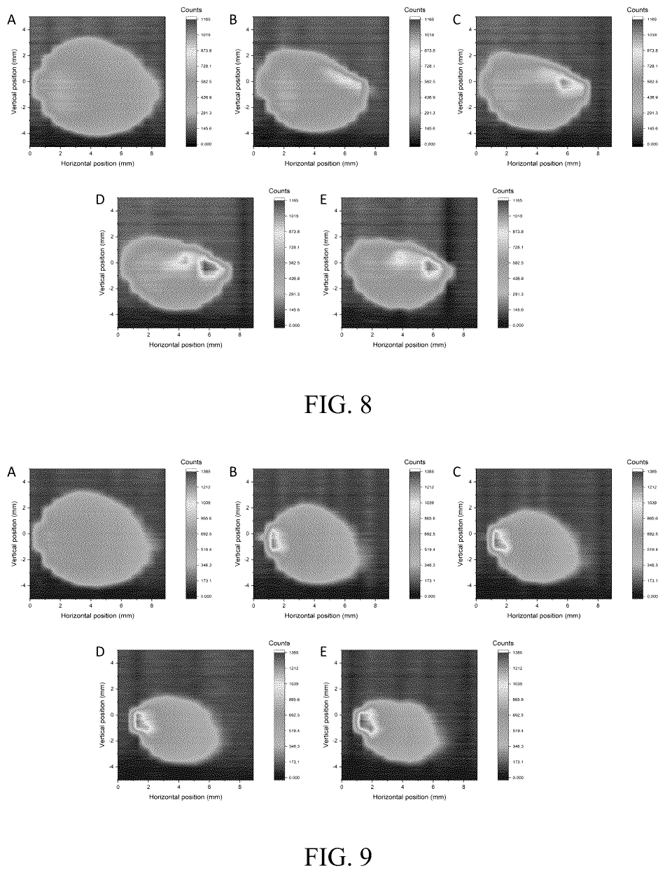

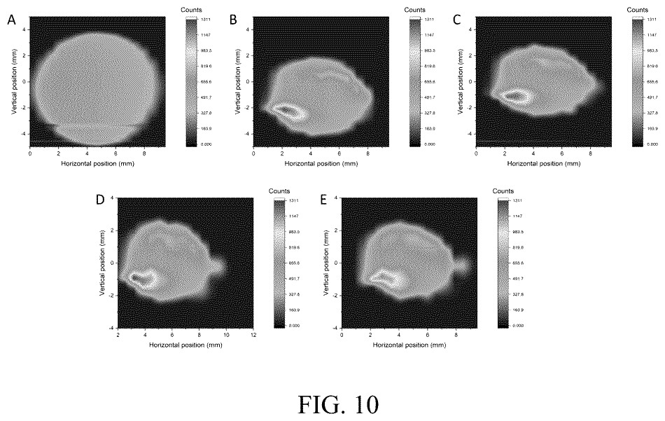

Control experiments with a 100 μM ethyl TAA solution, shown in FIG. 6, indicated that narrowing is only observed in the case where both the negative outside APCI and the positive ion spray are on. A control experiment in which a flat metal rod replaced the outside APCI needle showed no effect (FIG. 7), thus making it clear that generation of negative ions is crucial to the results shown here. Additional IonCCD images for other currents are shown in FIGS. 8 panels A-E, 9 panels A-E, and 10 panels A-E for the outside, inside, and both needles, respectively. The localization of focusing is consistent with the observations made in the SIMION simulations of FIG. 2 panels A-B.

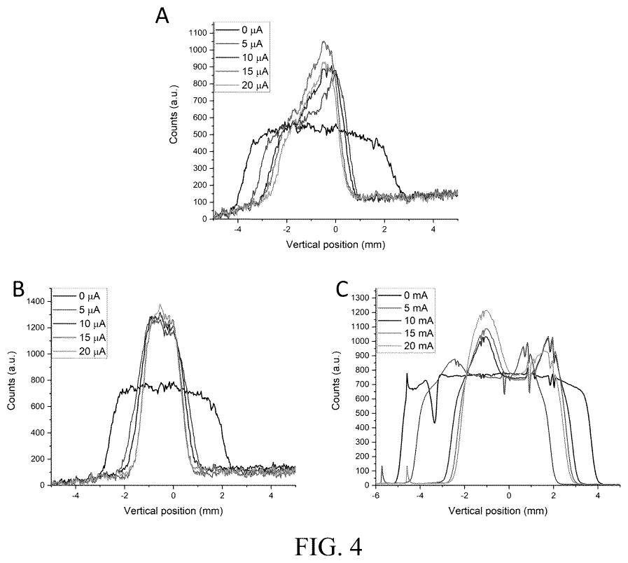

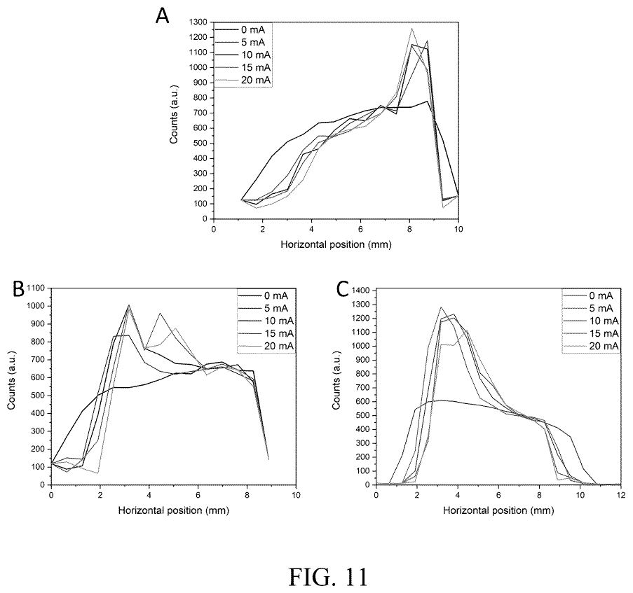

Vertical cross sections of ion packets observed with the outside needle (FIG. 4 panel A), inside needle (FIG. 4 panel B), and both needles (FIG. 4 panel C) under changing current conditions are shown in FIG. 4 panels A-C. In all cases the narrowest cross section was recorded near the area of highest intensity (6.4 mm horizontal position for the outside needle, 1.3 mm horizontal position for the inside needle, 4 mm horizontal position for both needles). In all cases, an increase in peak intensity is observed with increasing current along with a decrease in peak FWHM. The peak intensity shows little dependence on the APCI current used in the inside needle data, while the intensity in the outside needle case depends strongly on the current. For both the inside and outside cases the highest intensity of the beam is roughly double that of the no APCI case. Still, both APCI needles cause narrowing of the FWHM with increasing current, with the peaks in both cases having a FWHM ˜2 mm at the highest currents. Intriguingly, the current required to induce focusing in both cases is several orders of magnitude higher than the currents typically achieved via nESI (<10 nA). This suggests that the transmission of negative ions from the APCI needle and through the path of the device is rather inefficient. A further experiment in which the angle of the needle was varied in the negative ion inlet showed little dependence of the signal on the needle position. The horizontal cross sections (FIG. 11 panels A-C) show similar behavior to the vertical cross sections

The focusing that is observed is attributed to a reduction in space charge in the positive ion packet due to the influence of negative ions generated by APCI. The force of interaction between two isolated ions is given by Coulomb's law:

$${F}_{SC} = \frac{{q}_{1} {q}_{2}}{4 π {ε}_{0} {r}^{2}}$$

where q₁ and q₂ are the charges on ions 1 and 2 respectively, and r is the distance between the ions. When a third ion of opposite charge to the other two ions is added, the interaction between the two positive ions is the same, but now the ions also feel an attractive force from the negative ion, which in turn screens some of the space charge. This results in compression of the ion packet, as observed in FIG. 4 panel A-B. This compression is consistent with lessening of space charge. The observed asymmetry in the ion packets under focusing conditions is likely due, in part, to the uneven distribution of negative ions inside the electrode array, as demonstrated by the SIMION simulation in FIG. 2 panel B.

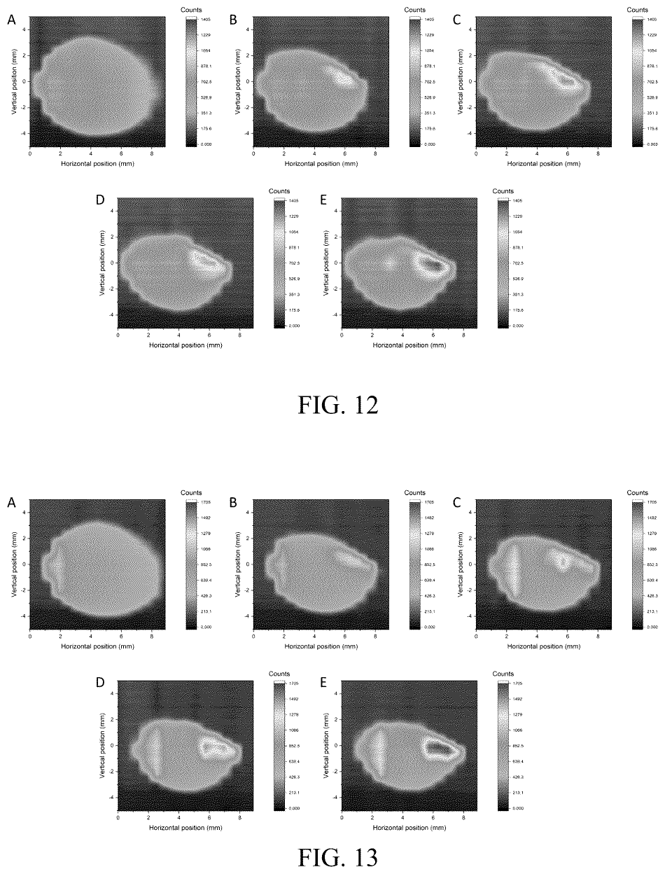

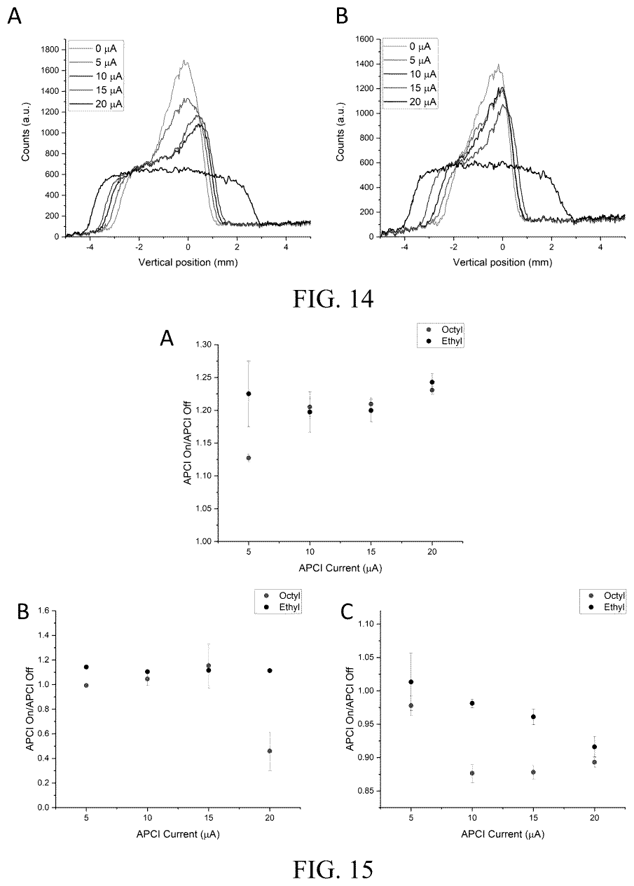

Although the mass of the charged particles is not explicitly considered in Coulomb's law, lower mass ions will feel a greater acceleration from the same electrostatic force compared to heavier ions. Therefore, it is important to understand the contributions of individual ions to the behavior observed in these experiments. An instructive comparison is between the behavior of the heaviest and lightest species in the mixture, examined individually. IonCCD images of a solution of 100 μM octyl TAA (FIG. 12 panels A-E) and ethyl TAA (FIG. 13 panels A-E) using the outside APCI needle as the negative ion source were recorded. The no-APCI images (FIG. 12 panel A and FIG. 13 panel A) look similar to the no-APCI image obtained in FIG. 3 panel A, although the intensity distribution in the ethyl TAA image is less symmetrical than the others. Cuts through the outside edge of the ion packet (FIG. 14 panels A-B) show that both the octyl and ethyl TAA have similar behavior with increasing current, although the peak intensity of the ethyl TAA is higher than that of the octyl TAA. The FWHM with increasing current is largely the same between the two species, indicating that ion identity has little influence on the focusing of ions.

### Effects on Mass Spectra

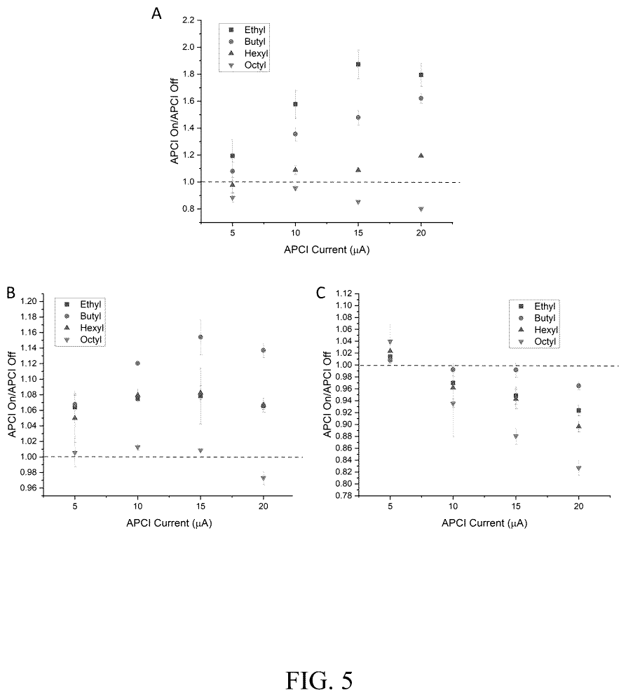

The extracted behavior of ethyl, n-butyl, n-hexyl, and n-octyl TAA species in the previously used mixture with increasing current on the outside APCI needle is shown in FIG. 5 panel A. The ethyl, butyl, and hexyl species show increasing intensity relative to the no APCI case with increasing currents of negative ions. Each of these species shows a different increase in intensity with current, with ethyl showing the highest increase, followed by butyl and hexyl. The octyl TAA shows a decrease in intensity with increasing current, counter to the trend of the other three species. In the inside needle case (FIG. 5 panel B), the enhancements observed are more modest than those for the outside needle case, but the ethyl, butyl, and hexyl TAA's still show enhancement with increasing current. Intriguingly, the butyl TAA shows the most enhancement using the inside needle, although the difference between the butyl and ethyl is much smaller than in the outside case. The octyl TAA, meanwhile, still shows very little enhancement or even decreasing intensity with increasing current. Using both APCI needles, held at the same current (FIG. 5 panel C), all TAA species in the mixture are observed to decrease in intensity with increasing current. Similar to the inside needle only case, the butyl TAA shows the lowest loss of intensity with increasing current. The effect is most severe with the octyl TAA, tracking with the outside and inside needle effects.

Experiments using the ethyl or octyl TAA (100 μM solution) alone were performed to understand how the isolated TAA's behave in the device with varying amounts of current. As shown in FIG. 15 panels A-C, the octyl alone shows slight enhancement with increasing current for the outside (FIG. 15 panel A) and inside (FIG. 15 panel B) needles, in contrast to the measurements in the mixture. Furthermore, the ethyl TAA shows increasing intensity, although the effect is much smaller than in the mixture. Both systems show decreasing enhancement with increasing current when both needles (FIG. 15 panel C) are used, consistent with the results for the mixture. The results here suggest that interactions between ions with differing mobilities are important in determining the effect of space charge as ions travel through the device. While the number of ions in solution are the same in the pure TAA case and the mixture case, there may be effects from the higher concentration of a single TAA in the pure ion case.

At atmospheric pressure, the parameter most relevant to ion motion is the electrical mobility. The results here, which show a relationship between the ion identity and signal enhancement with injected current, therefore imply that the electrical mobility of the ions is at the heart of the observed behavior. It is known that lighter (higher mobility) ions are more readily dispersed by space charge, meaning that they are the more likely to also be influenced by space charge compensation. Therefore, it is not surprising that the three lighter ions show much more enhancement with compensation than the heavy octyl TAA. The decrease in total intensity is consistent with the IonCCD image of the ion packet formed by using both APCI needles, which shows lower intensity than does either needle alone.

### CONCLUSIONS

This work demonstrated the usefulness of space charge neutralization by a counterion flow on a beam of low energy (<10 eV translational kinetic energy) ions at atmospheric pressure prior to entering a mass spectrometer. Counterion-induced focusing is shown through the use of a spatially resolved ion detector. It was observed that the ion distribution for a mixture of TAA's doubles in peak intensity and becomes three times narrower upon introduction of negative ions using either the inside or outside needle alone as their source. Using both needles results in highly symmetric focusing, in contrast to the inside or outside needle alone cases that cause focusing only on one side of the ion plume. Using either the inside or outside needle alone resulted in enhancements as high as 2× in the transmission of low mass ions in a mixture of TAA's and a decrease in transmission of the heaviest ion. These results suggest that a mobility effect is at play with respect to the transmission of space charge compensated ions. While the current study used ions generated by APCI that are likely highly reactive, embodiments using a gas that produces relatively inert ions are also contemplated, allowing for the more general use of this technique. Further enhancements of ion transport are contemplated through rational design of the atmospheric pressure ion guide to better accommodate beams of both polarities.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein.

1. An apparatus for ion focusing, the apparatus comprising:
A chamber having a distal end and a proximal end;
a first ion source positioned to introduce a first beam of ions into the chamber near the distal end and directed toward the proximal end; and
a second ion source positioned to introduce a second beam of ions oppositely charged to the first beam of ions into the chamber near the proximal end and directed toward the distal end;
wherein the first and second ion sources are positioned such that the second beam of ions interacts with the first beam of ions to focus the first beam of ions as it travels from the distal end toward the proximal end.

2. The apparatus of claim 1, wherein the chamber is an atmospheric ion guide.

3. The apparatus of claim 2, wherein the atmospheric ion guide is curved.

4. The apparatus of claim 1, further comprising a plurality of electrodes along walls of the chamber.

5. The apparatus of claim 4, wherein the plurality of electrodes are of a same polarity as the first beam of ions.

6. The apparatus of claim 5, wherein the plurality of electrodes are positioned successively along the chamber walls from the distal end to the proximal end, separated by dielectric material, and supplied with progressively lower voltages from the distal end to the proximal end.

7. The apparatus of claim 1, wherein the first and second ion sources are independently selected from the group consisting of electrospray ionization (ESI), nano electrospray ionization (nESI), atmospheric pressure chemical ionization (APCI), atmospheric Pressure Photoionization (APPI), desorption electrospray ionization (DESI), nano-DESI, matrix-assisted laser desorption/ionization (MALDI), and laser ablation electrospray ionization (LAESI).

8. The apparatus of claim 7, wherein the first ion source comprises nESI.

9. The apparatus of claim 8, wherein the second ion source comprises APCI.

10. The apparatus of claim 1, further comprising a third ion source positioned to introduce a third beam of ions oppositely charged to the first beam of ions into the chamber near the proximal end and directed toward the distal end;
wherein the first, second, and third ion sources are positioned such that the second beam and third beams of ions interact with the first beam of ions to focus the first beam of ions as it travels from the distal end toward the proximal end.

11. The apparatus of claim 10, wherein the second and third ion sources are positioned to introduce ions into the chamber at side walls of the chamber.

12. The apparatus of claim 11, wherein the second and third ion sources are positioned approximately opposite each other on the side walls of the chamber.

13. The apparatus of claim 1, further comprising a mass spectrometer positioned near an opening in the distal end of the chamber, the opening positioned at a focal point of the first beam of ions.

14. A method for focusing ions, the method comprising:
introducing a first beam of ions near a distal end of a chamber and directed toward a proximal end of the chamber; and
introducing a second beam of ions oppositely charged to the first beam of ions near the proximal end of the chamber and directed toward the distal end such that the second beam of ions interacts with the first beam of ions to focus the first beam of ions as it travels from the distal end toward the proximal end.

15. The method of claim 14, wherein the chamber is an atmospheric ion guide.

16. The method of claim 15, wherein the atmospheric ion guide is curved.

17. The method of claim 14, further comprising applying a voltage to a plurality of electrodes along walls of the chamber.

18. The method of claim 17, wherein the voltage is of a same polarity as the first beam of ions.

19. The method of claim 18, wherein the plurality of electrodes are positioned successively along the chamber walls from the distal end to the proximal end, separated by dielectric material, the method further comprising supplying each electrode from the distal end to the proximal end with progressively lower voltages.

20. The method of claim 14, further comprising introducing the first and second beams of ions from ion sources independently selected from the group consisting of electrospray ionization (ESI), nano electrospray ionization (nESI), atmospheric pressure chemical ionization (APCI), atmospheric Pressure Photoionization (APPI), desorption electrospray ionization (DESI), nano-DESI, matrix-assisted laser desorption/ionization (MALDI), and laser ablation electrospray ionization (LAESI).

21-26. (canceled)
